(19) United States
(12) Patent Application Publication
(10) Pub. No.: US 2011/0199499 A1
(43) Pub. Date: Aug. 18, 2011

(54) FACE RECOGNITION APPARATUS AND FACE RECOGNITION METHOD

(76) Inventor: Hiroto Tomita, Fukuoka (JP)

(21) Appl. No.: 12/743,460

(22) PCT Filed: Oct. 5, 2009
(86) PCT No.: PCT/JP2009/005160

§ 371 Date: May 18, 2010

(30) Foreign Application Priority Data
Oct. 14, 2008 (JP) 2008-265041

(51) Int. Cl. H04N 5/228; G06K 9/00

(52) U.S. Cl. 348/222.1; 382/103; 348/E05.031

(57) ABSTRACT

Provided is a face recognition apparatus which reduces a data transfer amount used in eye position detection processing and face feature extraction processing. First normalization means normalizes a face image to a certain size on a face image including a face detected by face detection means. Part detection means detects a part of the face by using a normalized face image. Second normalization means normalizes a face image to a certain size on a face image including the face detected by the face detection means. Feature extraction means extracts a feature amount of the face by using the normalized face image. Face image acquisition means acquires a face image to be processed by the normalization means by using a position and a size of the face detected by the face detection means. Face image acquisition selection means switches between a mode in which the face images to be used by the normalization means are individually acquired and a mode in which the face image is shared therebetween.

### TECHNICAL FIELD

The present invention relates to an art applied to an apparatus, a method, and the like for recognizing, by using an image of a person, the person captured in the image.

### BACKGROUND ART

In recent years, recognition processing using an image of a person, so-called face recognition technology, is attracting attention. The face recognition includes identification of a particular individual, of gender, of a facial expression, of age, and the like. The face recognition technology includes face detection processing for detecting a person's face from a captured image, and face recognition processing for recognizing the face based on the detected face image. Specifically, the face recognition processing includes feature point detection processing for detecting face feature points such as eyes, a mouth or the like of the face image, feature extraction processing for extracting a face feature amount, and identification processing for determining whether or not the face is a recognition target by using the feature amount.

For example, Patent Literature 1 discloses a technique as an example of the face recognition processing in which positions of both eyes are used as the face feature points, and a Gabor filter is used as a method of extracting the face feature amount.

FIG. 13 illustrates a face recognition system 70 of Patent Literature 1. FIG. 13 will be described. A captured image is stored in an SDRAM 74 and becomes an input image. A face detection unit 71 acquires the input image from the SDRAM 74, performs the face detection processing on the whole input image for every 24×24 pixels and calculates a size and a position of a detected face. A pixel-to-pixel difference method is used as the face detection processing method. A both-eye position detection unit 72 acquires a face image at the face position detected by the face detection unit 71, normalizes the face image into 24×24 pixels, and then detects positions of the both eyes by the pixel-to-pixel difference method similar to that used by the face detection unit 71. Based on the information of the detected positions of the both eyes, a face size, a face position, and a face angle are calculated. A face recognition unit 73 acquires again the face image specified by the both-eye position detection unit 72, normalizes the face image into 60×66 pixels, and then extracts a face feature. Gabor filtering is applied to the extraction of the face feature, and a degree of similarity between the application result and a result obtained by applying the Gabor filtering to a preliminarily registered image is calculated. Based on the degree of similarity, whether or not the face image is identical to the registered image is determined.

In the face feature extraction, the both-eye position detection unit 72 and the face recognition unit 73 require different resolutions of the normalized face image, and the face recognition unit 73 requires a higher resolution. This is because the face recognition processing requires an accuracy higher than that of the both-eye position detection processing. Accordingly, since the both-eye position detection unit 72 and the face recognition unit 73 are required to individually generate the normalized images, data of face images required for normalization is individually acquired.

### Citation List

### [Patent Literature]

[PTL 1] Japanese Laid-Open Patent Publication No. 2008-152530

### SUMMARY OF INVENTION

### Technical Problem

In the above-described conventional configuration, since the both-eye position detection unit 72 and the face recognition unit 73 normalize a processing target face image in different resolutions, data of the face images is individually acquired at all times. Consequently, there is a problem that an amount of data acquired from the SDRAM 74 is great.

In order to decrease the amount of data to be acquired, it is perceived to acquire, from the SDRAM 74, only data of lines required for the normalization processing, and to skip data of lines not required for the normalization processing. When a two-dimensional image is stored in the SDRAM 74 in raster order, a skip in a horizontal direction is less effective, but a skip in a vertical direction is easy and highly effective, in general. In the SDRAM 74, data of a plurality of pixels (e.g., 4 pixels) is stored in one word, and continuous multiple words are concurrently acquired in burst access, so that the skip in the horizontal direction causes many unnecessary pixels to be acquired. Accordingly, the skip in the horizontal direction is less effective. However, since the skip in the vertical direction extends over a number of words (e.g., 160 words in the case of 640×480 under the conditions of 4 pixels per word), the skip can be achieved only by an address control of the SDRAM 74, whereby the skip is easy as well as highly effective.

Here, assuming that a size of a face area to be acquired is S_FACE×S_FACE, a normalized size (24 in FIG. 13) at the both-eye position detection unit 72 is NX_EYE, and a normalized size (66 in FIG. 13) at the face recognition unit 73 is NX_EYE. Under these conditions, when the face image is acquired by performing the skip only in the vertical direction, an amount of data acquired by the both-eye position detection unit 72 is represented as S_FACE×NX_EYE, and an amount of data acquired by the face recognition unit 73 is represented as S_FACE×NX_EXT. Further, when the whole face area is acquired, an amount of data is represented as S_FACE×S_FACE as described above.

FIG. 8 illustrates total data transfer amounts required for performing recognition processing once in the respective cases where the both-eye position detection unit 72 and the face recognition unit 73 individually acquire the images, and where the both-eye position detection unit 72 and the face recognition unit 73 share data of the whole face area therebetween, the data having been transferred once. A horizontal axis indicates the size of the face area to be acquired, and a vertical axis indicates the total data transfer amount. The case of the individual transfer is indicated by (A) in which the transfer amount is proportional to the face area size. The case of the whole face area transfer is indicated by (B) in which the transfer amount is proportional to the square of the face area size. As illustrated in FIG. 8, when the face area size is less than a sum of the respective normalized sizes obtained by the both-eye position detection unit 72 and the face recognition unit 73, the total data transfer amount can be more greatly decreased when data of the whole face area is transferred.

However, in the above-described conventional configuration, the both-eye position detection unit 72 and the face recognition unit 73 individually acquire a face image at all times, which causes a problem that control of a data transfer method of the face image depending on the face area size is not allowed.

The present invention is to solve the above-described problems, and an object of the present invention is to control, depending on a face size, a data transfer method of face image data required for face recognition processing, thereby reducing a transfer amount.

### Solution to Problem

To solve the above the above-described problems, the face recognition apparatus of the present invention includes: face detection means that detects a face from an image in which the face is captured; first normalization means that normalizes a face image by resizing the face image to a certain size, the face image including the face detected by the face detection means; part detection means that detects a part of the face by using the face image normalized by the first normalization means; second normalization means that normalizes a face image by resizing the face image to a certain size, the face image including the face detected by the face detection means; feature extraction means that extracts a feature amount of the face by using the face image normalized by the second normalization means; and face image acquisition means that acquires one or more face images to be processed by the first normalization means and the second normalization means, depending on whether an acquisition mode is an individual acquisition mode in which face images to be used by the first normalization means and the second normalization means are individually acquired, or a shared acquisition mode in which a face image is acquired to be shared between the first normalization means and the second normalization means, by using position information and size information of the face detected by the face detection means; and face image acquisition selection means that selects and switches the acquisition mode for the face image acquisition means depending on the size information of the face detected by the face detection means, depending on the size normalized by the normalization means for the part detection means, and depending on the size normalized by the normalization means for the feature extraction means, wherein the face image acquisition selection means selects as the acquisition mode the individual acquisition mode in the case where the face size detected by the face detection means is greater than a sum of the size normalized by the first normalization means and the size normalized by the second normalization means, and selects as the acquisition mode the shared acquisition mode in the case where the face size detected by the face detection means is less than the sum.

By this configuration, a method for acquiring face image data can be set depending on a face size, whereby a data transfer amount required for the face recognition can be reduced.

### Advantageous Effects of Invention

According to the face recognition apparatus of the present invention, by controlling a transfer method of face image data depending on a face area size, a data transfer amount required for face recognition can be reduced.

### BRIEF DESCRIPTION OF DRAWINGS

FIG. 1 is a block diagram illustrating an exemplary configuration of a face recognition apparatus 1 according to a first embodiment of the present invention.

FIG. 2 is a diagram illustrating a process flow performed by the face recognition apparatus 1.

FIG. 3 is a diagram illustrating respective process flows performed in eye position detection processing and face feature extraction processing.

FIG. 4 is an explanatory diagram illustrating bilinear interpolation.

FIG. 5 is an explanatory diagram illustrating a process of acquiring an image from an SDRAM in an individual acquisition mode performed in the first embodiment of the present invention.

FIG. 6 is a schematic diagram illustrating data transfer amounts in the individual acquisition mode of the first embodiment of the present invention.

FIG. 7 is a schematic diagram illustrating data transfer amounts in a whole face area acquisition mode of the first embodiment of the present invention.

FIG. 8 is a diagram illustrating a relationship between total data transfer amounts in the individual acquisition mode and in the whole face area acquisition mode.

FIG. 9 is a diagram illustrating a process flow of switching of transfer modes performed by a face image acquisition unit.

FIG. 10 is an exemplary function block diagram of the face recognition apparatus 1 according to the first embodiment of the present invention.

FIG. 11A is a block diagram of a semiconductor integrated circuit 50 according to a second embodiment of the present invention.

FIG. 11B is a block diagram of a face recognition apparatus 1a according to the second embodiment of the present invention.

FIG. 12 is a block diagram of an image pickup device 80 according to a third embodiment of the present invention.

FIG. 13 is a block diagram of a face recognition apparatus 70 based on the conventional art.

### DESCRIPTION OF EMBODIMENTS

Hereinafter, respective embodiments of the present invention are described with reference to the drawings.

### First Embodiment

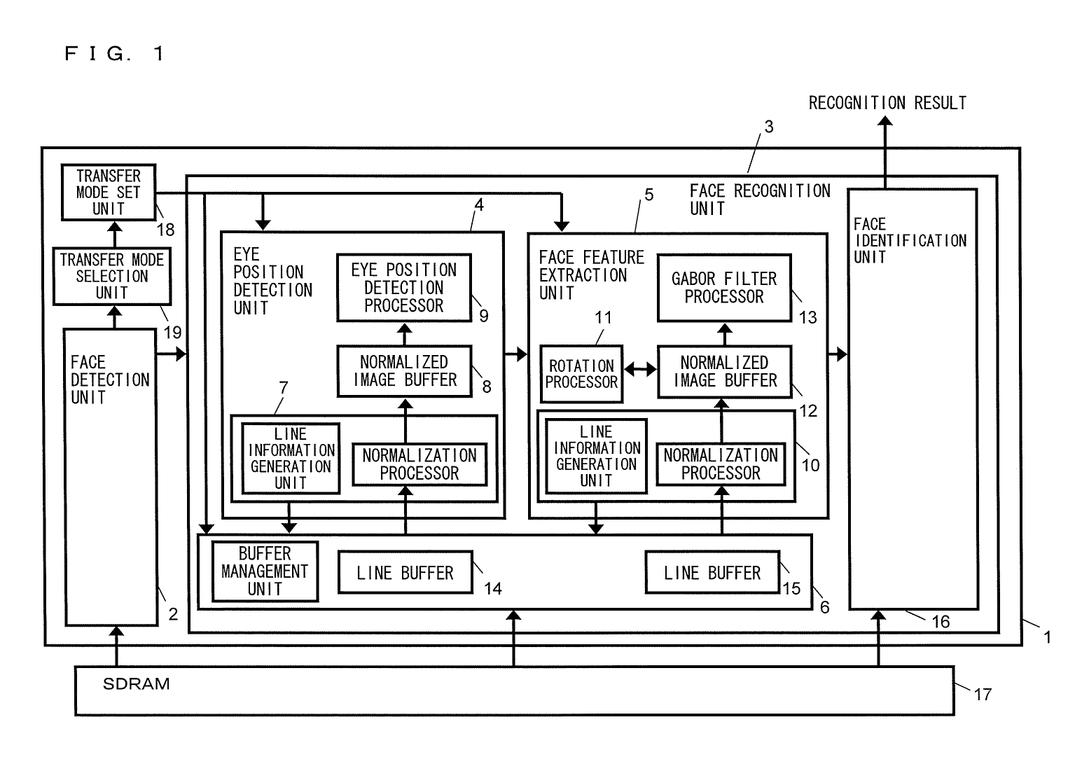

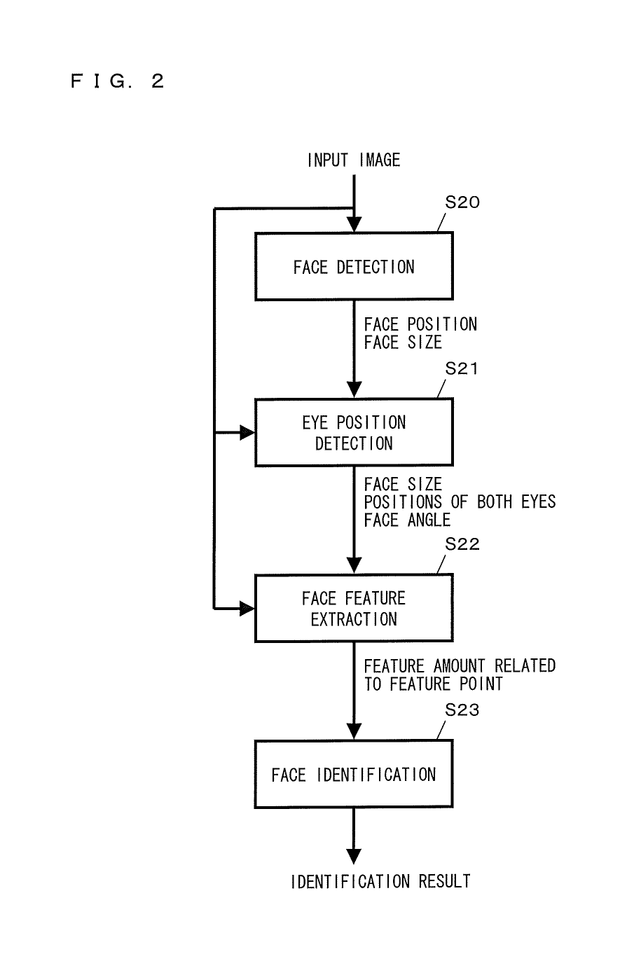

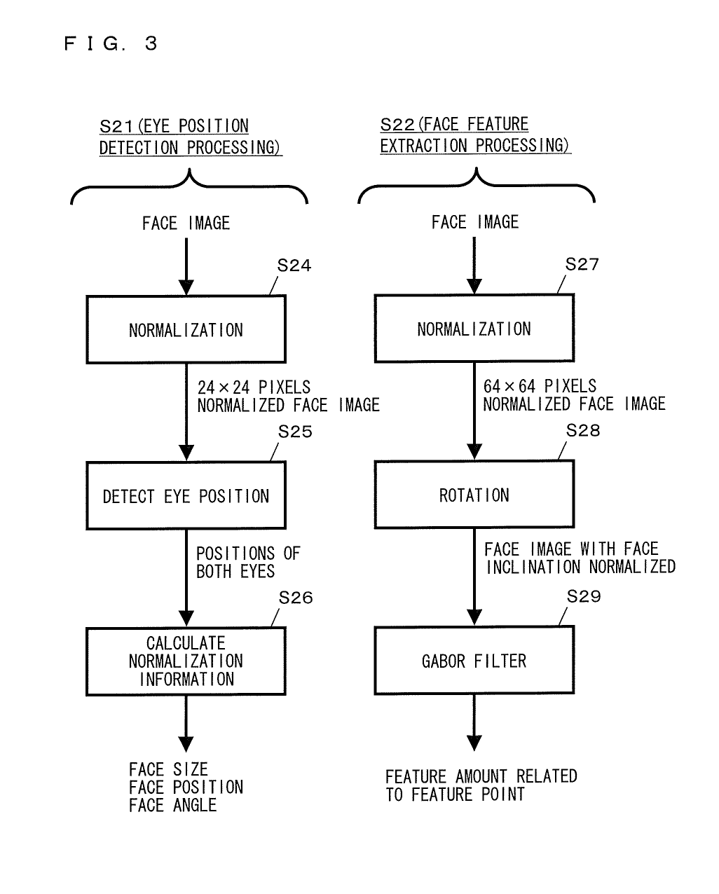

A face recognition apparatus 1 according to a first embodiment compares a feature amount extracted from an input face image with a feature amount extracted from a registered image, calculates a degree of similarity therebetween, and performs determination of face identification based on the degree of similarity. FIG. 1 is a diagram illustrating an exemplary configuration of the face recognition apparatus 1 in the first embodiment of the present invention. FIG. 2 and FIG. 3 are diagrams illustrating process flows performed by the face recognition apparatus 1.

Initially, an outline of the process flow performed by the face recognition apparatus 1 is described with reference to FIG. 2. As referred to FIG. 2, the face recognition apparatus 1 performs face detection on an input image so as to obtain a face position and a face size (step S20). Subsequently, the face recognition apparatus 1 acquires a face image based on the face position and the face size, detects positions of both eyes, and then calculates information of a face position, a face size, and a face angle based on the information of the position of the both eyes (step S21). Subsequently, the face recognition apparatus 1 normalizes the face image based on the information of the position of the both eyes, and extracts a feature amount of the face (step S22). The face recognition apparatus 1 compares the extracted feature amount with a preliminarily registered feature amount, and outputs the resultant as a recognition result (step S23).

FIG. 3 illustrates specific examples of process steps in step S21 and in step S22. Initially, eye position detection processing in step S21 is described with reference to FIG. 3. In step S21, when the face recognition apparatus 1 acquires a face image, the face recognition apparatus 1 normalizes the acquired face image into a predetermined size (24×24 pixels in this embodiment) (step S24). Subsequently, the face recognition apparatus 1 detects positions of both eyes from the normalized face image (step S25), and calculates a face position, a face size, and a face angle as normalization information based on the positions of the both eyes (step S26).

Next, the face feature extraction processing in step S22 is described with reference to FIG. 3. In step S22, when the face recognition apparatus 1 acquires a face image, the face recognition apparatus 1 normalizes the acquired face image into a predetermined size (64×64 pixels in this embodiment) (step S27). Subsequently, the face recognition apparatus 1 rotates the face image so as to correct an inclination thereof (step S28), and calculates a face feature amount related to face feature points by using a Gabor filter (step S29).

Next, the configuration of FIG. 1 is described.

In FIG. 1, the face recognition apparatus 1 includes a face detection unit 2, a face recognition unit 3, a transfer mode set unit 18, and a transfer mode select unit 19, the transfer mode set unit 18 and the transfer mode select unit 19 functioning as face image acquisition selection means. The face recognition unit 3 includes an eye position detection unit 4 functioning as part detection means, a face feature extraction unit 5 functioning as feature extraction means, a face identification unit 16, and a face image acquisition unit 6. The eye position detection unit 4 includes a normalization processor 7, a normalized image buffer 8, and an eye position detection processor 9. The face feature extraction unit 5 includes a normalization processor 10, a normalized image buffer 12, a rotation processor 11, and a Gabor filter processor 13.

The face detection unit 2 acquires a captured image stored in an SDRAM 17 so as to perform face detection processing. In the face detection processing, detected face position information and detected face size information are outputted as detection results and passed to the face recognition unit 3. The face recognition unit 3 acquires, based on the detected face position information and the detected face size information, a face image in a face image area required for each of the eye position detection unit 4 and the face feature extraction unit 5, and passes the face images to the respective normalization processors 7 and 10.

In the eye position detection unit 4, the normalization processor 7 performs, by using the face size detected by the face detection unit 2, normalization of the face size into a size required for the eye position detection processing, and stores the normalized face image in the normalized image buffer 8. The eye position detection processor 9 performs eye position detection processing on the face image stored in the normalized image buffer 8 so as to detect positions of the both eyes as well as calculates information of a face position, a face size, and a face angle thereof. The calculated information of the face position, the face size, and the face angle are passed to the face feature extraction unit 5.

In the face feature extraction unit 5, the normalization processor 10 performs, by using the face size detected by the eye position detection unit 4, normalization of the face size into a size required for the face feature extraction processing, and stores the normalized face image in the normalized image buffer 12. The rotation processor 11 performs rotation processing by using the face angle detected by the eye position detection unit 4, and newly stores the resultant face image in the normalized image buffer 12. The Gabor filter processor 13 performs Gabor filtering on the face image stored in the normalized image buffer 12, and the resultant is outputted to the face identification unit 16 as a feature amount. The face identification unit 16 acquires a preliminarily registered feature amount of a face image from the SDRAM 17 so as to compare the preliminarily registered feature amount with the feature amount outputted from the face feature extraction unit 5. A comparison result is outputted as a face recognition result.

Next, the respective components are described in detail.

The face detection unit 2 detects a person's face from a captured image stored in the SDRAM 17, and outputs a position of the detected face, a size of the detected face, and the like as a detection result. The face detection unit 2 may be configured to detect a face by performing template identification using a reference template corresponding to a facial contour, for example. Alternatively, the face detection unit 2 may be configured to detect a face by performing template identification based on facial parts (eyes, nose, ears, and the like). Still alternatively, the face detection unit 2 may be configured to detect an area in a color similar to a skin color so as to recognize the area as a face. Still alternatively, the face detection unit 2 may be configured to perform learning based on a teacher signal by using a neural network so as to detect a face-like area as a face. Still alternatively, the face detection processing performed by the face detection unit 2 may be realized by application of any existing techniques.

Further, when a plurality of person's faces are detected from a captured image, a target to be processed by the face recognition unit 3 may be determined based on certain standards such as a face position, a face size, a face orientation, and the like. Of course, all of the detected faces may be determined as face recognition targets. The order of processing these targets may be determined based on the above described certain standards. As a result, information of a face detection result is passed to the face recognition unit 3.

The normalization processor 7 in the eye position detection unit 4 generates, from the captured image stored in the SDRAM 17, a normalized image required for the eye position detection processing. To be specific, initially, by using information of the face position and the face size obtained as the face detection result, a scale factor used in the normalization processing, and a position and a range of the face area sufficient to include the detected face are calculated. Alternatively, the normalization processor 7 may calculate the range greater than or smaller than the face size obtained as the face detection result. The scale factor is represented as Mathematical Formula 1.

(scale factor)=(input face image size)/(normalization size) [Math. 1]

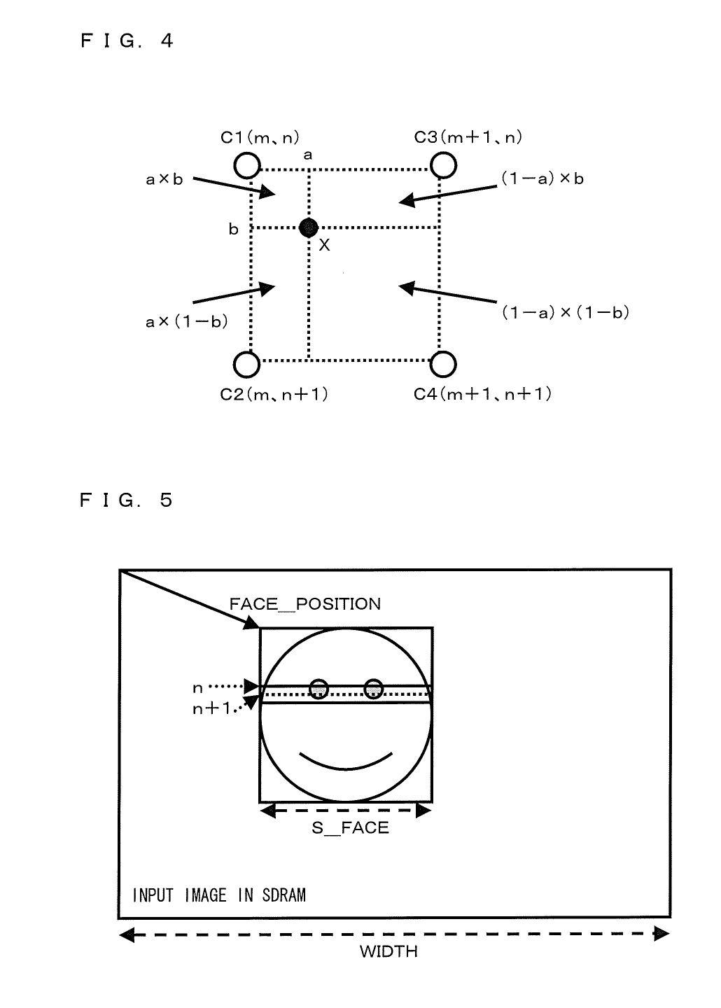

Based on the information of the calculated position and range of the face area, line information and the face size (width) which are required for the normalization processing are calculated, and a face image is acquired from the face image acquisition unit 6. In this embodiment, the reason why only the line information required for the normalization processing is acquired is to reduce the transfer amount of the face image data as described above. The normalization processing to resize the acquired face image depending on the scale factor is performed, and the face image is stored in the normalized image buffer 8. For example, as a method of the normalization processing, bilinear interpolation is used. The bilinear interpolation is illustrated in FIG. 4 and represented as Mathematical Formula 2.

$$( bilinear filter ) = C 1 \times \{ ( 1 - a ) \times ( 1 - b ) \} + C 2 \times \{ ( 1 - a ) \times b \} + C 3 \times \{ a \times ( 1 - b ) \} + C 4 \times \{ a \times b \} \qquad [ Math . 2 ]$$

In the bilinear interpolation, a pixel position after resizing is calculated with decimal precision based on the scale factor, and a pixel value is calculated, by carrying out linear interpolation, based on four integer pixels surrounding the decimal-precision pixel. As illustrated in FIG. 4, areas of rectangular regions each specified by two vertexes which are a pixel position X after resizing and either one of four surrounding integer pixels C1, C2, C3, or C4, become filter coefficients.

The line information indicating line positions required for the normalization processing can be calculated based on the scale factor and the normalization processing method. When the normalization processing method is the above-described bilinear interpolation, the lines required for the normalization processing are only two lines existing above and below the pixel position after resizing, the pixel position being determined depending on the scale factor. For example, when the scale factor is ¼, the two lines are a line 4n (n=0, 1, 2, . . . ) and a line 4n+1.

The face image acquisition unit 6 is allowed to operate in two transfer modes (acquisition modes), and includes a line buffer 14, a line buffer 15, and a buffer manager. The buffer manger manages operations of the line buffers 14 and 15 as well as controls accesses between the line buffer 14 and 15, and the normalization processors 7 and 10. The face image acquisition unit 6 changes, depending on the transfer mode set by the transfer mode set unit 18, a method of acquiring a face image to be used by the eye position detection unit 4 and the face feature extraction unit 5. In this embodiment, an individual transfer mode and a whole face area transfer mode are used as the two transfer modes.

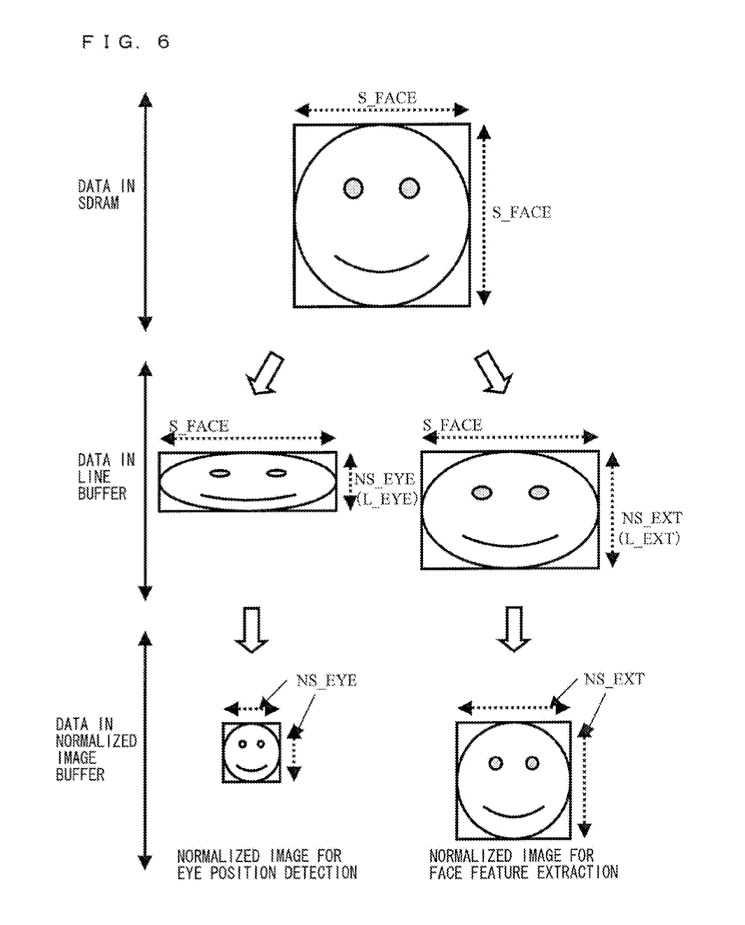

The individual transfer mode is a mode in which the face images are individually acquired in the eye position detection processing and the face feature extraction processing. Accordingly, the individual transfer mode may be referred to as the individual acquisition mode. In the individual transfer mode, the face image acquisition unit 6 calculates addresses of the SDRAM 17 based on pieces of the information of the required lines in the face image, the pieces of information being outputted from the eye position detection unit 4 and the face feature extraction unit 5, respectively, and acquires data from the SDRAM 17 line by line. An acquisition process is described with reference to FIG. 5. Required information is an upper left corner face position (FACE_POSITION) with reference to the SDRAM 17 and a face area width (S_FACE), which are calculated from an output from the face detection unit 2, the line information (n and n+1 in FIG. 5) outputted from the eye position detection unit 4 or from the face feature extraction unit 5, and an image width (WIDTH) of an input image.

Initially, the face image acquisition unit 6 calculates a beginning address of the required lines based on the upper left corner face position (FACE_POSITION), the image width (S_FACE) of the input image, and the line information (n), resulting in FACE_POSITION+WIDTH×n. When data of the face area width (S_FACE) is acquired from the beginning address, data in the first line can be acquired. Subsequently, regarding data acquisition in the second line, the beginning address is similarly calculated as FACE_POSITION+WIDTH×(n+1). When data of the face area width (S_FACE) is acquired from the beginning address in the same way, data in the second line can be acquired. By repeatedly performing the above processes, only data of the required lines is acquired from the SDRAM 17. The pieces of line data acquired from the SDRAM 17 are stored in the individual line buffers respectively used for the eye position detection processing and the face feature extraction processing, and the pieces of the line data are respectively outputted to the eye position detection unit 4 and the face feature extraction unit 5.

The whole face area transfer mode is a mode in which a whole image of the face area is acquired, and the acquired data is shared between the eye position detection processing and the face feature extraction processing. Accordingly, the whole face area transfer mode may be referred to as a shared acquisition mode. In the whole face area transfer mode, the face image acquisition unit 6 acquires data of the whole face area from the SDRAM 17 and temporarily stores the data of the whole face area in the line buffer. As a process of transfer from the SDRAM 17, the process performed in the individual transfer mode may be referenced. The face image acquisition unit 6 outputs, from the data of the whole face area stored in the line buffers, the pieces of the required line data to the eye position detection unit 4 and to the face feature extraction unit 5, respectively, depending on the pieces of required line information in the face image respectively outputted from the eye position detection unit 4 and the face feature extraction unit 5.

Further, when a plurality of person's faces are to be recognized, the eye position detection unit 4 and the face feature extraction unit 5 may be operated to perform parallel processing based on pipeline operations for face recognition of different persons. At this time, the line buffers of the face image acquisition unit 6 are separated into two regions such that the pieces of line data for the eye position detection unit 4 and the face feature extraction unit 5 are respectively stored in the two regions in the individual transfer mode. In the whole face area transfer mode, in order to cause the two regions to function as pipeline buffers, data of the whole face area being processed by the eye position detection unit 4 is stored in one region, and data of the whole face area being processed by the face feature extraction unit 5 is stored in the other region.

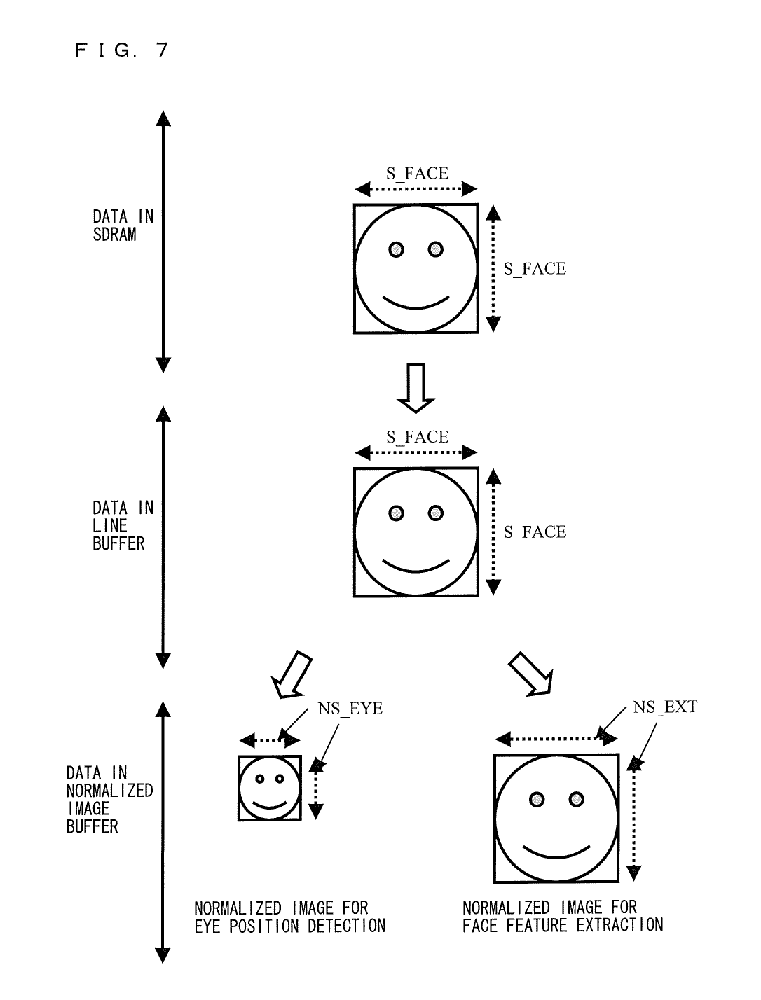

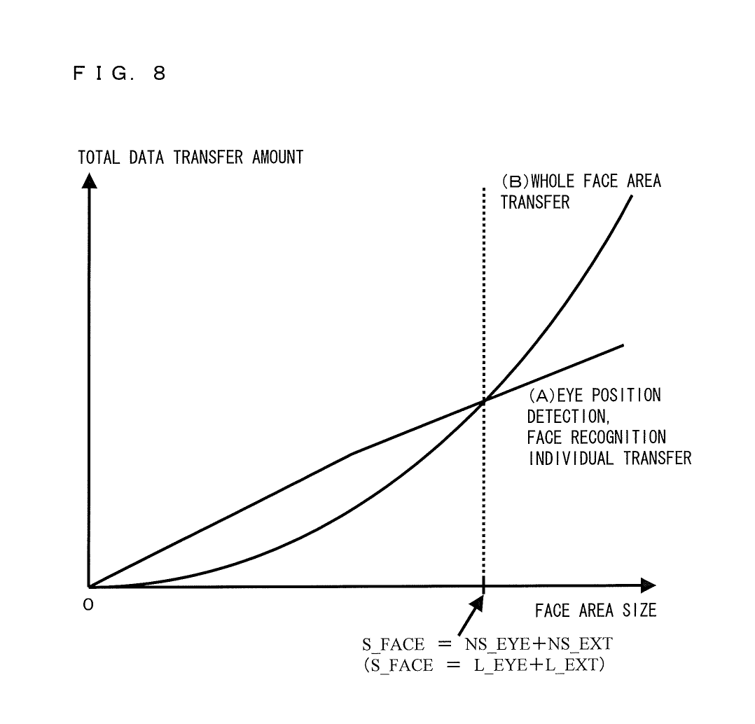

FIG. 6 and FIG. 7 are schematic diagrams illustrating a difference between data transferred in the two transfer modes. In this embodiment, S_FACE represents the face size of the face detection result, NS_EYE represents the normalized size in the eye position detection, and NS_EXT represents the normalized size in the face feature extraction. Further, L_EYE represents the number (L_EYE=NX_EYE×2 in the case of the bilinear interpolation) of lines required for the normalization processing performed in the eye position detection processing, and L_EXT represents the number of lines required for the normalization processing performed in the face feature extraction processing. FIG. 6 illustrates a flow of data transferred in the individual transfer mode. Under these conditions, a data transfer amount from the SDRAM 17 required for the eye position detection processing is represented as Mathematical Formula 3, and a data transfer amount from the SDRAM 17 required for the face feature extraction processing is represented as Mathematical Formula 4. Accordingly, a total data transfer amount is represented as Mathematical Formula 5. FIG. 7 illustrates a flow of data transferred in the whole face area transfer mode. A data transfer amount from the SDRAM 17 is equal to the data amount of the whole face area and represented as Mathematical Formula 6.

(data transfer amount for eye position detection)=S_FACE×L_EYE=S_FACE×NS_EYE×(the number of filter taps) [Math. 3]

(data transfer amount for face feature extraction)=S_FACE×L_EXT=S_FACE×NS_EXT×(the number of filter taps) [Math. 4]

(data transfer amounts for eye position detection+face feature extraction)=S_FACE×NS_EYE×2+S_FACE×NS_EXT×2 [Math. 5]

(data transfer amount of one face)=S_FACE×S_FACE [Math. 6]

The eye position detection processor 9 in the eye position detection unit 4 detects eye positions in a face from the normalized image stored in the normalized image buffer 8, and calculates the face size, the face position, the face angle, and the like based on the information of the detected eye positions. The eye position detection in the face can be realized by using pattern identification or a neural network. Alternatively, the eye position detection processing performed by the eye position detection processor 9 may be realized by application of any other existing techniques.

Various kinds of information may be calculated from the information of the eye position of the face as follows, for example. The face position can be calculated from positions of the both eyes, and the face size can be obtained by calculating a distance between the both eyes based on the information of the positions of the both eyes. The face angle can be obtained by calculating an angle with respect to horizontal positions of the both eyes based on the information of the positions of the both eyes. Of course, these methods are merely examples, and the various kinds of information may be calculated by using other methods.

The normalization processor 10 in the face feature extraction unit 5 performs the same processing as that in the normalization performed in the eye position detection processing. However, a scale factor is different therefrom. Information calculated by the eye position detection unit 4 is used as the face size information, and the normalized size is the size required for the face feature extraction processing. The scale factor must be calculated based on those pieces of information.

The rotation processor 11 in the face feature extraction unit 5 changes the face image to a front face image based on affine transformation so as to align the positions of the eyes along the same horizontal line (i.e., the inclination of the face is at an angle of 0 with respect to a vertical line). This rotation processing is realized by performing the affine transformation on the face image stored in the normalized image buffer 12 by using the face angle information calculated by the eye position detection unit 4, and rewriting the resultant in the normalized image buffer 12. Alternatively, a face orientation may be rotated by performing the affine transformation. Still alternatively, the rotation processing for the face image may be realized by a method other than the affine transformation.

The Gabor filter processor 13 in the face feature extraction unit 5 performs Gabor Wavelet transformation on one or more feature points in the normalized face image. The Gabor filter is represented as Mathematical Formula 7.

$${ϕ}_{k , θ} ( x , y ) = \frac{{k}^{2}}{{σ}^{2}} exp [ - \frac{{k}^{2} ( {x}^{2} + {y}^{2} )}{2 {σ}^{2}} ] \cdot \{ exp [ i k ( x cos θ + y sin θ ) ] - exp ( - \frac{{σ}^{2}}{2} ) \} \qquad [ Math . 7 ]$$

Periodicity and directionality of a gray-scale feature around the feature point are obtained by the Gabor filter as the feature amount. As the position of the feature point, neighboring points of the face parts (eyes, nose, mouth) can be used, and the position may be any position that coincides with a position at which a feature amount of a registered image subjected to identification has been obtained. The same is true for the number of the feature points.

The face identification unit 16 compares the feature amount extracted by the face feature extraction unit 5 with the preliminarily registered feature amount, and then calculates a degree of similarity therebetween. When the calculated degree of similarity is the highest value thereamong and exceeds a threshold value of the degree of similarity, the face compared is recognized as the person registered and the registration result is outputted. Alternatively, face identification processing performed by the face identification unit 16 may be realized by application of any existing techniques. For example, the feature amounts may not directly be compared but may be compared after a certain transformation.

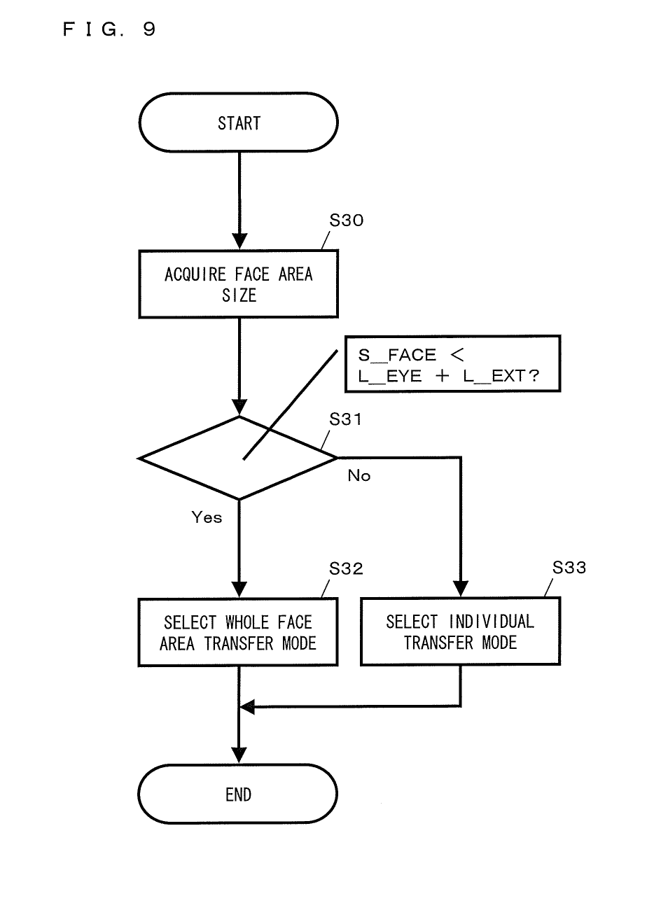

FIG. 8 illustrates a relationship between a total data transfer amount, required for processing performed by the eye position detection unit 4 and that required for processing performed by the face feature extraction unit 5. As described above, the data transfer amounts are calculated based on Mathematical Formula 2, Mathematical Formula 3, Mathematical Formula 4, and Mathematical Formula 5. In these formulas, a variable is the face area size (S_FACE) in the input image. Accordingly, when each of the data transfer amounts is regarded as a function of the face area size, the total data transfer amount in the individual transfer mode is indicated by a linear function proportional to the face area size, and the data transfer amount in the whole face area transfer mode is indicated by a quadratic function proportional to a square of the face area size. Consequently, by selecting either one of the two transfer modes depending on the face area size, the data transfer amount required for the face recognition can be reduced.

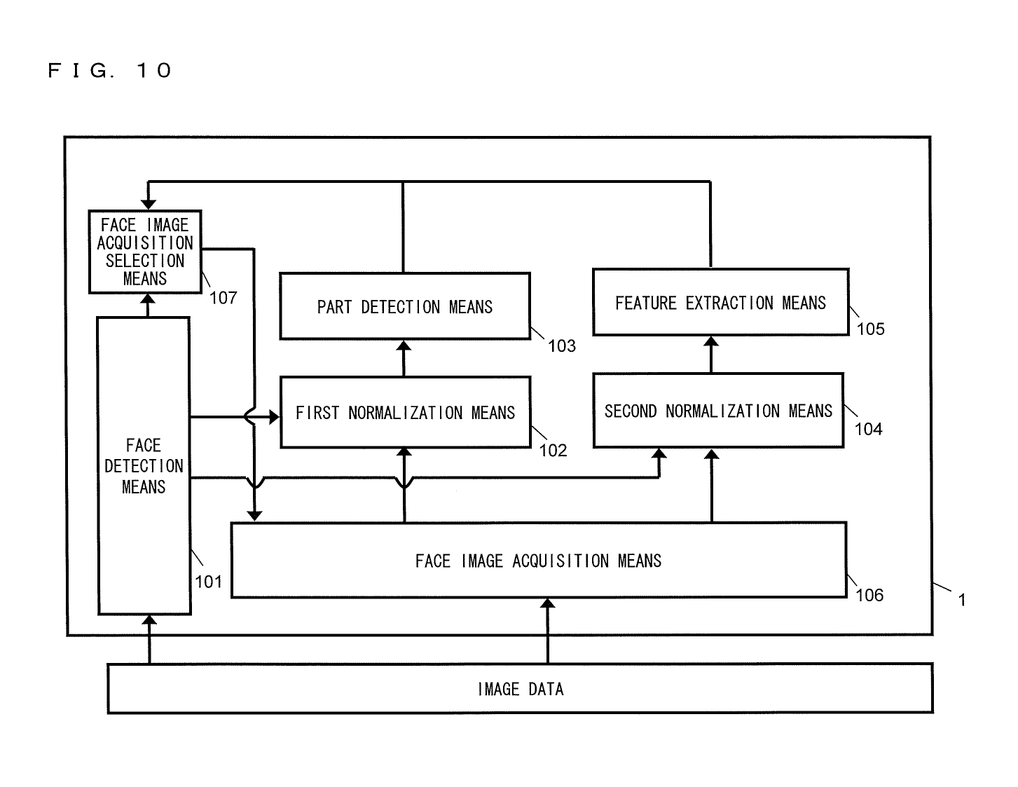

FIG. 9 illustrates an example of a method for selecting either one of the two transfer modes. As referred to FIG. 9, the transfer mode select unit 19 acquires the face area size (S_FACE) detected by the face detection unit 2 (step S30). Subsequently, the transfer mode select unit 19 compares the face area size (S_FACE) with the sum (L_EYE+L_EXT) of the normalized sizes respectively obtained by the eye position detection unit 4 and the face feature extraction unit 5 (step S31). When the face area size (S_FACE) is smaller than the sum (L_EYE+L_EXT), the transfer mode select unit 19 selects the whole face area transfer mode (step S32), and when the face area size (S_FACE) is equal to or greater than the sum (L_EYE+L_EXT), the transfer mode select unit 19 selects the individual transfer mode (step S33).

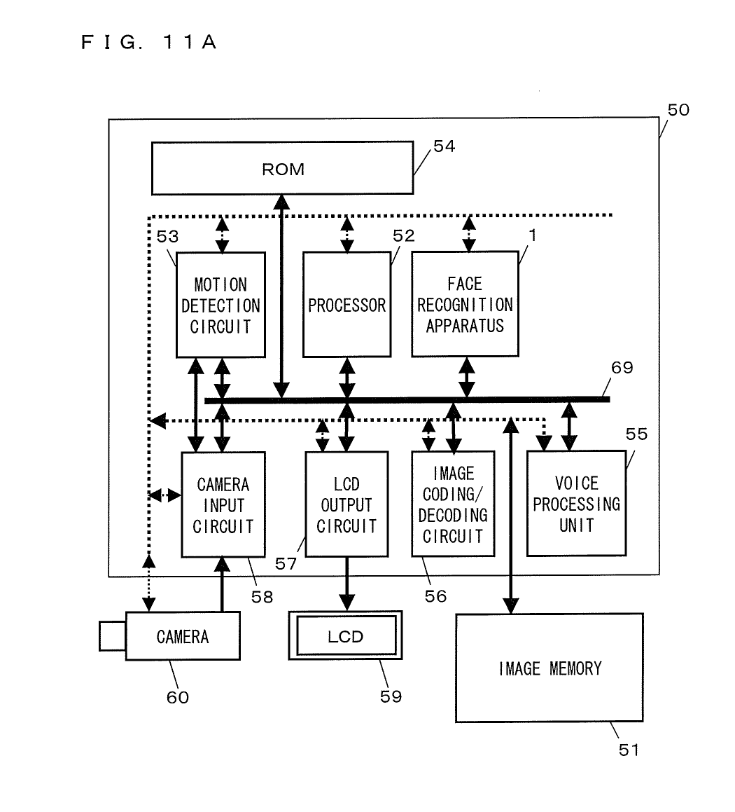

FIG. 10 is a function block diagram of the above-described face recognition apparatus 1. In FIG. 10, the face recognition apparatus 1 includes face detection means 101, first normalization means 102, part detection means 103, second normalization means 104, feature extraction means 105, face image acquisition means 106, and face image acquisition selection means 107. Operations of the respective function blocks are described below.

The face detection means 101 detects a face from an image in which the face is captured. The first normalization means 102 performs normalization processing for resizing, to a certain size, a face image including the face detected by the face detection means 101. The part detection means 103 detects a part of the face by using the face image normalized by the first normalization means 102. The second normalization means 104 performs normalization processing for resizing, to a certain size, a face image including the face detected by the face detection means 101. The feature extraction means 105 extracts a feature amount of the face by using the face image normalized by the second normalization means 104.

The face image acquisition means 106 acquires, depending on whether an acquisition mode is an individual acquisition mode for individually acquiring face images to be used by the first normalization means 102 and the second normalization means 104, or a shared acquisition mode for acquiring the face image to be shared therebetween, image data of the face image to be processed by the first and the second normalization means 102 or 104, by using the face position information and the face size information detected by the face detection means 101. The face image acquisition selection means 107 selects and switches between the acquisition modes for the face image acquisition means 106 depending on the face size information detected by the face detection means 101, and depending on the sizes respectively normalized by the normalization means in the part detection means 103 and the normalization means in the feature extraction means 105.

### Second Embodiment

The respective function blocks included in the above-described face recognition apparatus 1 can be realized as an LSI which is an integrated circuit. The function blocks may be individually single-chipped, or may be single-chipped so as to partly or entirely include these function blocks. Although the chip is referred to here as the LSI, the chip may be referred to as an IC, a system LSI, a super LSI, or an ultra LSI depending on an integration density thereof.

Alternatively, the method of integration is not limited to the LSI, and may be realized by a dedicated circuit or a general-purpose processor. Still alternatively, an FPGA (Field Programmable Gate Array) which is programmable after manufacturing the LSI, or a reconfigurable processor enabling reconfiguration of connection or setting of circuit cells in the LSI may be used. Still further, in the case where another integration technology replacing the LSI becomes available due to an improvement of a semiconductor technology or due to emergence of another technology derived therefrom, the function blocks may be integrated using such a new technology. For example, biotechnology may be applied.

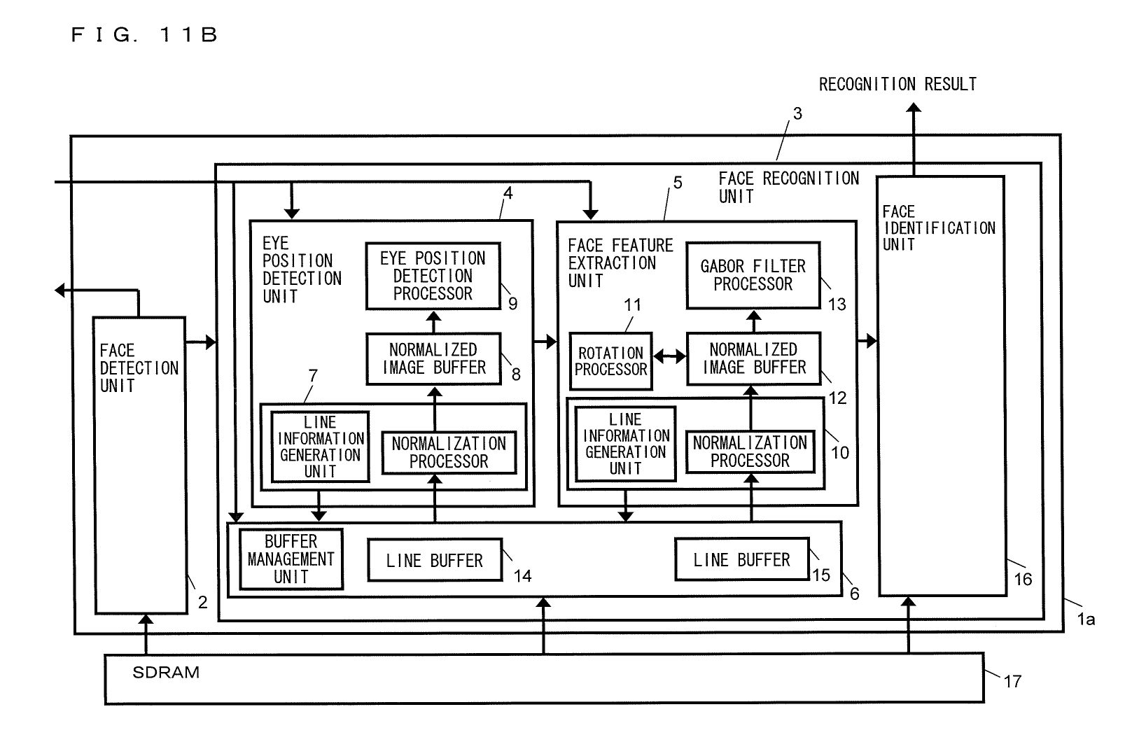

FIG. 11A is a block diagram illustrating an example of a semiconductor integrated circuit according to the second embodiment of the present invention. In FIG. 11A, the semiconductor integrated circuit 50 includes MOS transistors such as CMOSs, in general, and realizes a specific logical circuit depending on a connection structure of the MOS transistors. In recent years, integration degree of the semiconductor integrated circuit is increased such that a highly complicated logical circuit (e.g., the face recognition apparatus 1 of the present invention) can be realized by one or several semiconductor integrated circuits.

The semiconductor integrated circuit 50 includes the face recognition apparatus 1 described in the first embodiment, and a processor 52. Further, the face recognition apparatus 1 included in the semiconductor integrated circuit 50 acquires an input image from an image memory 51 via an internal bus 69.

The semiconductor integrated circuit 50 may include, other than the face recognition apparatus 1 and the processor 52, if needed, an image coding/decoding circuit 56, a voice processing unit 55, a ROM 54, a camera input circuit 58, and an LCD output circuit 57.

The face recognition apparatus 1 included in the semiconductor integrated circuit 50 realizes, as described in the first embodiment, the face recognition processing which reduces the data transfer amount depending on the face area size.

Alternatively, the semiconductor integrated circuit 50 may realize some of the functions of the face recognition apparatus 1 by using the processor 52. For example, the semiconductor integrated circuit 50 may include a face recognition apparatus 1a illustrated in FIG. 11B. In FIG. 11B, the face recognition apparatus 1a realizes the functions of the transfer mode set unit 18 and the transfer mode select unit 19 by using the processor 52 without including the transfer mode set unit 18 and the transfer mode select unit 19.

When the face recognition apparatus 1 is realized as the semiconductor integrated circuit 50, downsizing, low power consumption, and the like of the face recognition apparatus 1 can be realized.

### Third Embodiment

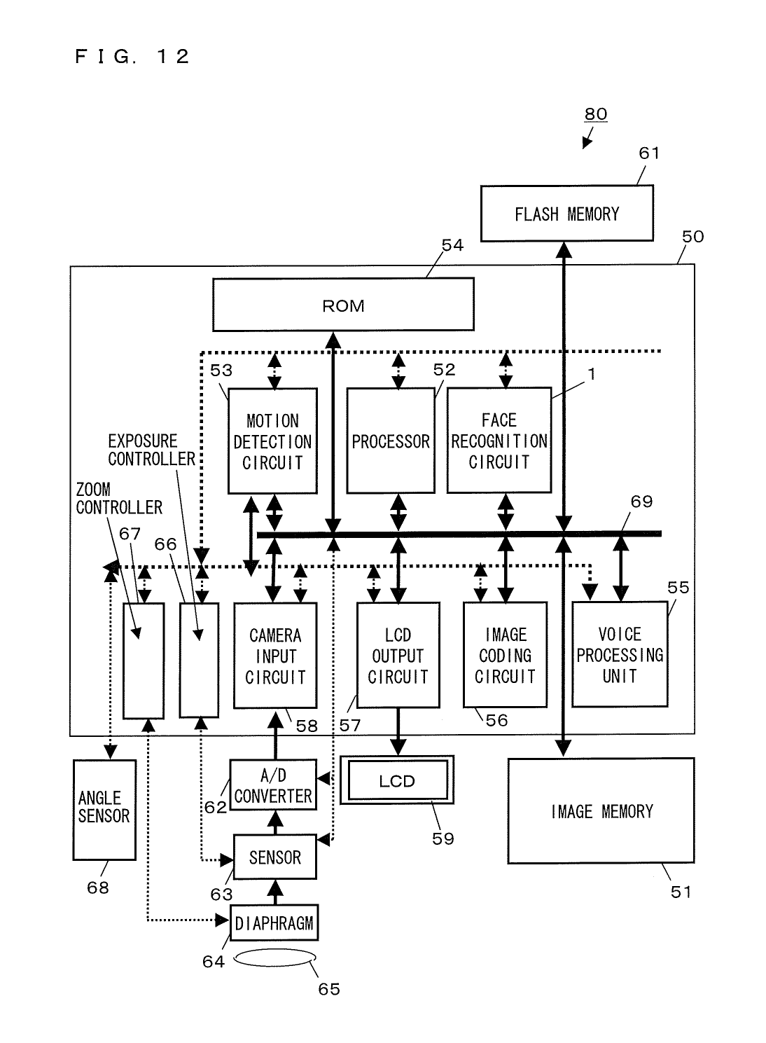

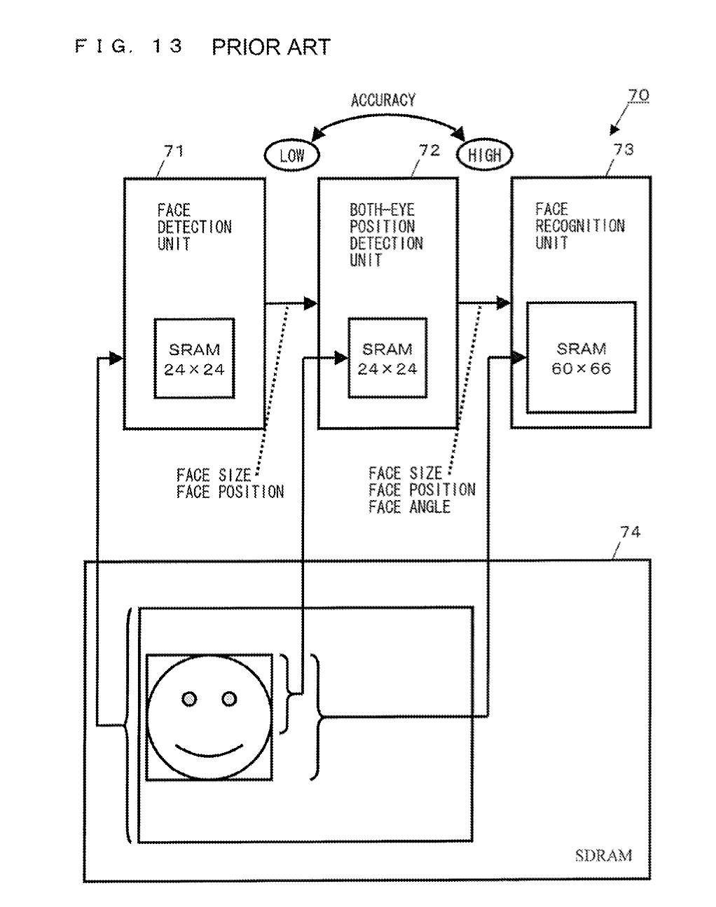

A third embodiment is described with reference to FIG. 12. FIG. 12 is a block diagram illustrating an image pickup apparatus according to the third embodiment of the present invention. In FIG. 12, an image pickup device 80 includes the semiconductor integrated circuit 50 described in the second embodiment, a lens 65, a diaphragm 64, a sensor 63 such as a CCD, an A/D converter 62, an angle sensor 68, a flash memory 61, and the like. The A/D converter 62 converts an analog output from the sensor 63 into a digital signal. The angle sensor 68 detects a shooting angle of the image pickup device 80. The flash memory 61 stores a feature amount (a registered feature amount) of a face to be subjected to recognition.

The semiconductor integrated circuit 50 includes, in addition to the blocks described in the second embodiment, a zoom controller 67 for controlling the lens 65, and an exposure controller 66 for controlling the diaphragm 64.

By using the face position information recognized by the face recognition apparatus 1 of the semiconductor integrated circuit 50 and registered in the flash memory 61, focus control of the zoom controller 67, and exposure control of the exposure controller 66 each focusing on a face position of a particular face such as a family member face, for example, can be performed. Accordingly, the image pickup device 80 capable of clearly shooting the family member face can be realized.

Further, the respective processing steps executed by the face recognition apparatus 1 described in the respective embodiments may be realized by a CPU interpreting and executing predetermined program data capable of executing the above-described processing steps stored in a storage device (a ROM, a RAM, a hard disc, and the like). In this case, the program data may be introduced into the storage device via a storage medium, or may be directly executed on the storage medium. Here, the storage medium includes: a semiconductor memory such as a ROM, a RAM, a flash memory and the like; a magnetic disc memory such as a flexible disc, a hard disc, and the like; an optical disc memory such as a CD-ROM, a DVD, a BD, and the like; and a memory card and the like. Further, the storage medium is a notion including a communication medium such as a phone line, a carrier path, and the like.

### INDUSTRIAL APPLICABILITY

The face recognition apparatus according to the present invention is capable of reducing data transfer amount of the face recognition processing, for example, and is useful as a face recognition apparatus or the like in a digital camera. Further, the face recognition apparatus of the present invention is also applicable to uses for a digital movie camera, a monitoring camera, and the like.

### REFERENCE SIGNS LIST

1 face recognition apparatus

2 face detection unit

3 face recognition unit

4 eye position detection unit

5 face feature extraction unit

6 face image acquisition unit

7 normalization processor in eye position detection unit

8 normalized image buffer in eye position detection unit

9 eye position detection processor in eye position detection unit

10 normalization processor in face feature extraction unit

11 rotation processor in face feature extraction unit

12 normalized image buffer in face feature extraction unit

13 Gabor filter processor in face feature extraction unit

16 face identification unit

50 semiconductor integrated circuit

51 image memory

52 processor

53 motion detection circuit

54 ROM

55 voice processing unit

56 image coding circuit

57 LCD output circuit

58 camera input circuit

59 LCD

60 camera

61 flash memory

62 A/D converter

63 sensor

64 diaphragm

65 lens

66 exposure controller

67 zoom controller

68 angle sensor

69 internal bus

101 face detection means

102 first normalization means

103 part detection means

104 second normalization means

105 feature extraction means

106 face image acquisition means

107 face image acquisition selection means

80 image pickup apparatus

1. A face recognition apparatus comprising:
face detection means that detects a face from an image in which the face is captured;
first normalization means that normalizes a face image by resizing the face image to a certain size, the face image including the face detected by the face detection means;
part detection means that detects a part of the face by using the face image normalized by the first normalization means;
second normalization means that normalizes a face image by resizing the face image to a certain size, the face image including the face detected by the face detection means;
feature extraction means that extracts a feature amount of the face by using the face image normalized by the second normalization means; and
face image acquisition means that acquires a face image to be processed by the first normalization means and the second normalization means, depending on whether an acquisition mode is an individual acquisition mode in which face images to be used by the first normalization means and the second normalization means are individually acquired, or a shared acquisition mode in which a face image is acquired to be shared between the first normalization means and the second normalization means, by using position information and size information of the face detected by the face detection means; and
face image acquisition selection means that selects and switches the acquisition mode for the face image acquisition means, depending on the size information of the face detected by the face detection means, depending on the size normalized by the normalization means for the part detection means, and depending on the size normalized by the normalization means for the feature extraction means, wherein
the face image acquisition selection means selects as the acquisition mode the individual acquisition mode in the case where the face size detected by the face detection means is greater than a sum of the size normalized by the first normalization means and the size normalized by the second normalization means, and selects as the acquisition mode the shared acquisition mode in the case where the face size detected by the face detection means is less than the sum.

2. The face recognition apparatus according to claim 1, wherein the face image acquisition means further comprises:
first and second image data storage means that store the image data acquired; and
image data storage control means that controls access from the first and the second normalization means to the first and the second image data storage means, wherein
when the acquisition mode is the individual acquisition mode, the image data storage control means controls only the first normalization means to be allowed to access the first image data storage means, and controls only the second normalization means to be allowed to access the second image data storage means, and
when the acquisition mode is the shared acquisition mode, the image data storage control means controls both of the first and the second image data storage means to be allowed to access the first and the second normalization means.

3. The face recognition apparatus according to claim 1, wherein when the size of the face detected by the face detection means is greater than a sum of a value obtained by multiplication of the size normalized by the first normalization means, by the number of taps for a filter used in resizing processing, and a value obtained by multiplication of the size normalized by the second normalization means, by the number of taps for a filter used in resizing processing, the face image acquisition selection means selects as the acquisition mode the individual acquisition mode, and when the face size is less than the sum of the values, the face image acquisition selection means selects as the acquisition mode the shared acquisition mode.

4. A face recognition method comprising:
a face detection step of detecting a face from an image in which the face is captured;
a first normalization step of performing normalization processing for resizing a face image to a certain size, the face image including the face detected in the face detection step;
a part detection step of detecting a part of the face by using the face image normalized in the first normalization step;
a second normalization step of performing normalization processing for resizing a face image to a certain size, the face image including the face detected in the face detection step;
a feature extraction step of extracting a feature amount of the face by using the face image normalized in the second normalization step; and
a face image acquisition step of acquiring a face image to be processed in the first normalization step and in the second normalization step, depending on whether an acquisition mode is an individual acquisition mode in which face images to be used in the first normalization step and used in the second normalization step are individually acquired, or a shared acquisition mode in which a face image is acquired to be shared in the first normalization step and in the second normalization step, by using face position information and size information of the face detected in the face detection step; and
a face image acquisition selection step of selecting and switching the acquisition mode depending on the size information of the face detected by the face detection means, depending on the size normalized in the part detection step, and depending on the size normalized in the feature extraction step, wherein
the face image acquisition selection step selects as the acquisition mode the individual acquisition mode in the case where the face size detected in the face detection step is greater than a sum of the size normalized in the first normalization step and the size normalized in the second normalization step, and selects as the acquisition mode the shared acquisition mode in the case where the face size detected in the face detection step is less than the sum.

5. A semiconductor integrated circuit which includes a face recognition apparatus, the semiconductor integrated circuit integrating circuits which act as:
face detection means that detects a face from an image in which the face is captured;
first normalization means that normalizes a face image by resizing the face image to a certain size, the face image including the face detected by the face detection means;
part detection means that detects a part of the face by using the face image normalized by the first normalization means;
second normalization means that normalizes a face image by resizing the face image to a certain size, the face image including the face detected by the face detection means;
feature extraction means that extracts a feature amount of the face by using the face image normalized by the second normalization means; and
face image acquisition means that acquires a face image to be processed by the first normalization means and the second normalization means, depending on whether an acquisition mode is an individual acquisition mode in which face images to be used by the first normalization means and the second normalization means are individually acquired, or a shared acquisition mode in which a face image is acquired to be shared between the first normalization means and the second normalization means, by using face position information and size information of the face detected by the face detection means; and
face image acquisition selection means that selects and switches the acquisition mode for the face image acquisition means depending on the size information the face detected by the face detection means, depending on the size normalized by the part detection means, and depending on the size normalized by the feature extraction means, wherein
the face image acquisition selection means selects as the acquisition mode the individual acquisition mode in the case where the face size detected by the face detection means is greater than a sum of the size normalized by the first normalization means and the size normalized by the second normalization means, and selects as the acquisition mode the shared acquisition mode in the case where the face size detected by the face detection means is less than the sum.

6. The semiconductor integrated circuit according to claim 5 further comprising a processor, wherein the processor realizes the face image acquisition selection means.

7. An image pickup apparatus comprising:
external storage means that stores an image in which a face is captured;
face detection means that acquires, from the external storage means, the image in which a face is captured, and detects the face from the acquired image;
first normalization means that normalizes a face image by resizing the face image to a certain size, the face image including the face detected by the face detection means;
part detection means that detects a part of the face by using the face image normalized by the first normalization means;
second normalization means that normalizes a face image by resizing the face image to a certain size, the face image including the face detected by the face detection means;
feature extraction means that extracts a feature amount of the face by using the face image normalized by the second normalization means; and
face image acquisition means that acquires, from the external storage means, a face image to be processed by the first normalization means and the second normalization means, depending on whether an acquisition mode is an individual acquisition mode in which face images to be used by the first normalization means and the second normalization means are individually acquired, or a shared acquisition mode in which a face image is acquired to be shared between the first normalization means and the second normalization means, by using position information and size information of the face detected by the face detection means; and
face image acquisition selection means that selects and switches the acquisition mode for the face image acquisition means depending on the size information of the face detected by the face detection means, depending on the size normalized by the part detection means, and depending on the size normalized by the feature extraction means, wherein
the face image acquisition selection means selects as the acquisition mode the individual acquisition mode in the case where the face size detected by the face detection means is greater than a sum of a size normalized by the first normalization means and a size normalized by the second normalization means, and selects as the acquisition mode the shared acquisition mode in the case where the face size detected by the face detection means is less than the sum.

8. The face recognition apparatus according to claim 2, wherein when the size of the face detected by the face detection means is greater than a sum of a value obtained by multiplication of the size normalized by the first normalization means, by the number of taps for a filter used in resizing processing, and a value obtained by multiplication of the size normalized by the second normalization means, by the number of taps for a filter used in resizing processing, the face image acquisition selection means selects as the acquisition mode the individual acquisition mode, and when the face size is less than the sum of the values, the face image acquisition selection means selects as the acquisition mode the shared acquisition mode.
